(19) United States
(12) Patent Application Publication
(10) Pub. No.: US 2008/0271712 A1
(43) Pub. Date: Nov. 6, 2008

(54) CARBON DEPOSIT RESISTANT COMPONENT

(75) Inventors: Hind M. Abi-Akar, Peoria, IL (US); Xiangyang Jiang, Dunlap, IL (US); Jorge R. Agama, Peoria, IL (US); Mark W. Jarrett, Washington, IL (US); Kurtis C. Kelley, Washington, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 12/127,359

(22) Filed: May 27, 2008

Related U.S. Application Data
(63) Continuation-in-part of application No. 11/131,743, filed on May 18, 2005, now Pat. No. 7,383,806.

(51) Int. Cl. F02M 61/16; C25D 11/00; B05D 1/18

(52) U.S. Cl. 123/468; 205/317; 427/430.1

(57) ABSTRACT

Carbon deposits on engine components can negatively affect engine performance. An engine of the present disclosure includes at least one carbon deposit resistant engine component attached to an engine housing. The engine component includes at least one relatively high surface tension surface that is a non-contact wear surface and to which a relatively low surface tension coating is attached. The relatively low surface tension coating has a surface tension at least one of equal to and less than 30 dyne/cm.

### CROSS-REFERENCE TO RELATED APPLICATION

This application is a continuation-in-part application based on U.S. Ser. No. 11/131,743, filed May 18, 2005.

### TECHNICAL FIELD

The present disclosure relates generally to internal combustion engines, and more specifically to components associated with the engine or aftertreatment system and reducing carbon deposits thereon.

### BACKGROUND

It is known that oil deterioration and the combustion process within internal combustion engines can create the accumulation of carbon deposits, sometimes referred to as carbon packing, on surfaces of engine components, and negatively affect the performance of the component and engine. In fact, carbon packing on engine components can decrease fuel economy, increase undesirable emissions, and eventually lead to a loss in engine power. Specifically, carbon packing can occur on ring grooves defined by an engine piston and in which rings are positioned to seal the space between an annular side surface of the piston and a cylinder liner. The carbon packing on the ring grooves can alter the position of the rings, increasing the tension between the liner and the rings. In extreme cases, the piston can become stuck, potentially causing catastrophic engine failure.

Moreover, carbon packing on the annular surface of the engine piston can make contact with the cylinder liner. As the piston reciprocates, the rings seal the combustion area, during combustion, at the piston-liner area. Further, the rings move oil from the crankcase to the top of the piston-liner area, creating a thin surface of oil to lubricate the liner-ring motion. Carbon packing in the piston-liner area causes more oil to be moved into the combustion chamber than desired. The excess oil interferes with the combustion of the fuel, resulting in decreased fuel efficiency. Further, the excess oil in the combustion chamber contributes to even more carbon packing and to undesirable emissions.

Carbon deposits caused by oil can occur in engine components other than pistons. For instance, an oil cooler includes a bundle of tubes through which coolant passes. As heated oil passes over the tubes, the heated oil can form deposits that adhere to the coolant tubes. The deposits can decrease the life the of the tubes, and decrease the thermal transfer efficiency between the coolant and the passing oil. In addition, components such as the tip of the injector nozzle or components in a regeneration system may also have carbon deposits thereon.

Over the years, engineers have sought methods of limiting carbon packing and deposits without making major alterations to the engine. For instance, carbon-resistant coatings, such as the coating described in U.S. Pat. No. 5,771,873, issued to Potter et al., on Jun. 30, 1998, have been applied to surfaces of engine components adjacent to and/or within the combustion chamber. The Potter carbon-resistant coating is an amorphous hydrogenated carbon film coating that is believed to prevent carbon packing because the coating is supposedly chemically inert with respect to deposit formation chemistry. The amorphous hydrogenated carbon film coating is illustrated for use on surfaces of intake valve, exhaust valves, fuel injectors and pistons which are exposed to the combustion chamber. However, the amorphous hydrogenated carbon film coating is fragile, and may not be able to withstand the limited movement, or lashing, of the piston rings against the annular sides surface of the piston as the piston reciprocates. Thus, the amorphous hydrogenated carbon film coating is not suitable for certain engine components, such as the annular surface of the piston.

The present disclosure is directed at overcoming one or more of the problems set forth above.

### SUMMARY OF THE INVENTION

In one aspect of the present disclosure, an engine, with at least one carbon deposit resistant component, includes at least one engine component attached to or positioned within the engine housing. The engine component includes at least one relatively high surface tension surface that is a non-contact wear surface and to which a relatively low surface tension coating is attached. The relatively low surface tension coating includes a surface tension that is at least one of equal to and less than 30 dyne/cm.

In another aspect of the present disclosure, carbon deposits on at least one non-contact wear surface of an engine component are reduced by coating at least one relatively high surface tension surface of the engine component with a relatively low surface tension material. The relatively low surface tension material includes a surface tension that is at least one of equal to and less than 30 dyne/cm.

In yet another aspect of the present disclosure, a carbon deposit resistant engine piston includes a piston body that includes at least one relatively high surface tension surface. The relatively high surface tension surface is a non-contact wear surface to which a relatively low surface tension coating that includes a surface tension that is at least one of equal to and less than 30 dyne/cm is attached.

### BRIEF DESCRIPTION OF THE DRAWINGS

FIG. 1 is a schematic representation of a an engine, according to the present disclosure;

FIG. 2 is a partial sectioned diagrammatic view of a piston within a cylinder of the engine of FIG. 1; and

FIG. 3 is a front sectioned diagrammatic view of an oil cooler for the engine of FIG. 1.

FIG. 4 is a diagrammatic view of an active regeneration system according to this disclosure.

### DETAILED DESCRIPTION

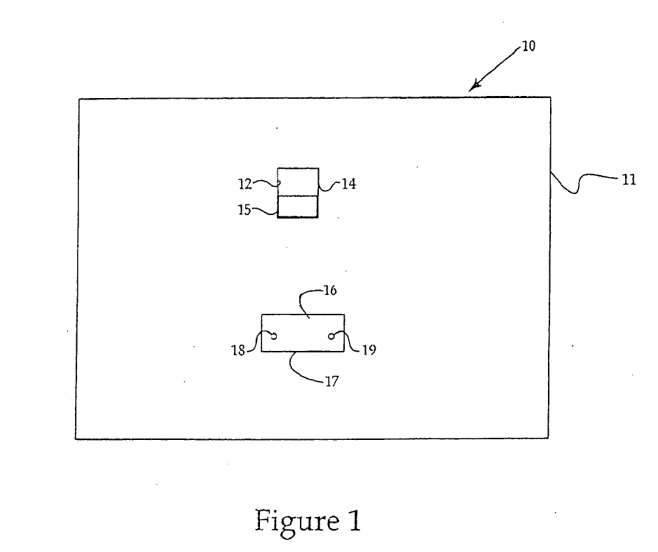

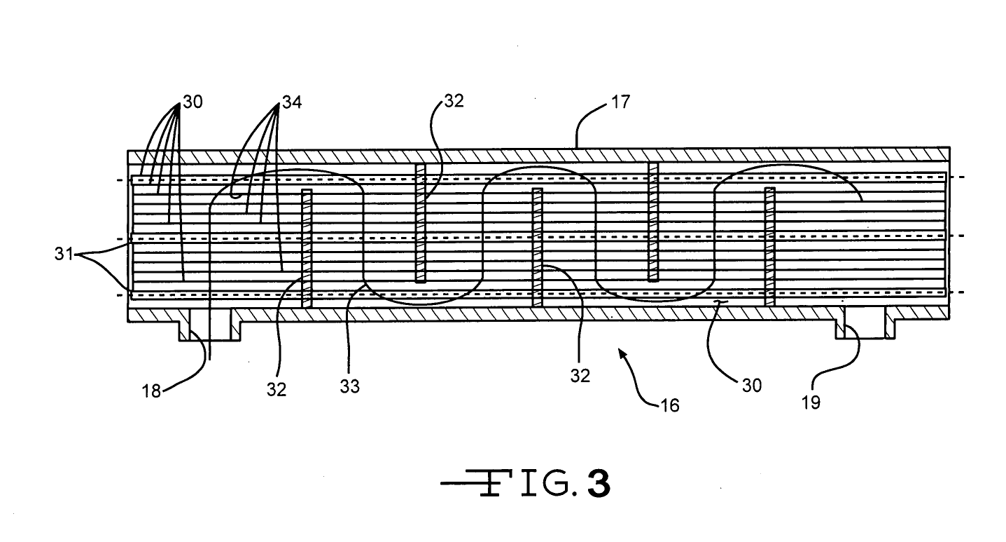

Referring to FIG. 1, there is shown a schematic representation of an engine 10, according to the present disclosure. The engine 10 includes an engine housing 11 to which at least two carbon resistant engine components are attached or positioned. Although the carbon resistant engine components are preferably an engine piston 15 and and/or oil cooler 16 that includes at least one coolant tube (shown in FIG. 3), it should be appreciated that the present disclosure contemplates an engine with various other carbon resistant engine components, including any suitable non-wear surface. For example, the carbon resistant component may be a fuel injector, wherein the tip or nozzle is coated with the coating described herein. Further, some components outside of the engine itself is within the scope of this disclosure. Specifically, any components of an aftertreatment, regeneration, or exhaust system where carbon deposits are prone to form may be coated as described herein to form a carbon resistant component. Such components include, e.g., the regenerations system's nozzle used to mix fuel and air, the head, and the swirl plate.

The engine housing 11 defines at least one engine cylinder 14 in which at least one combustion chamber 12 is disposed. The engine piston 15 that is operably connected to a crank shaft (not shown) and is moveable between a bottom dead center position and a top dead center position in the engine cylinder 14. An oil cooler 16 is attached to the engine housing 11. The oil cooler 16 includes a cooler housing 17 that defines an oil inlet 18 and an oil outlet 19. The oil flowing through the oil cooler 16 passes over an outer surface of a plurality of coolant tubes, which are often copper, (shown in FIG. 3) through which coolant passes. The coolant absorbs the heat from the oil. Thus, the oil exiting the outlet 19 is cooler than the oil entering the inlet 18.

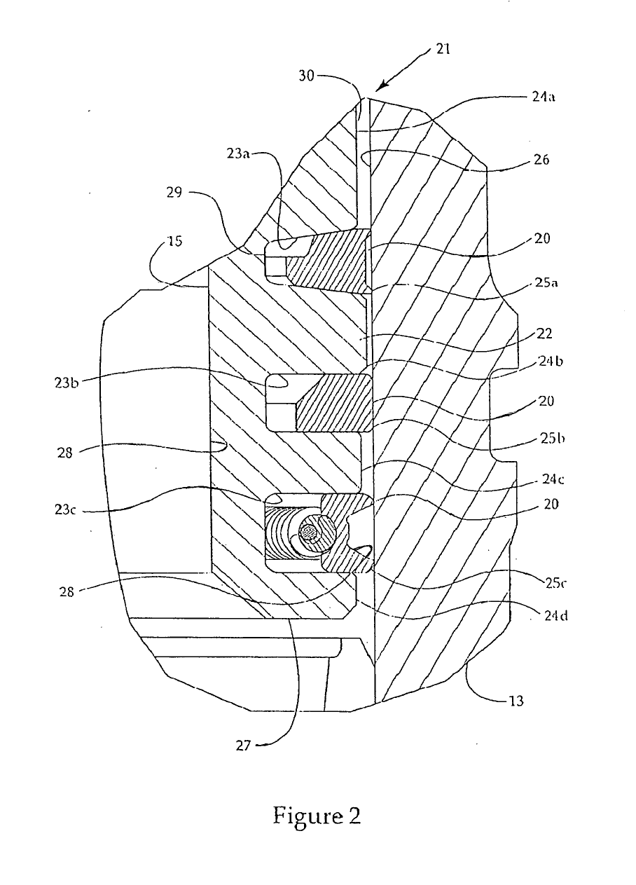

Referring to FIG. 2, there is shown a partial sectioned diagrammatic view of the piston 15 within the engine cylinder 14 of the engine 10 of FIG. 1. FIG. 2 is an enlargement of a piston-liner area 21 of the engine cylinder 14. Preferably, an engine cylinder liner 13 is positioned between the engine housing 11 defining the cylinder 14 and the piston 15, and includes an annular inner surface 26. The piston 15 includes a body 29 that includes at least one relatively high surface tension surface, preferably being an annular side surface 22. The piston body 29 may be comprised of various materials, such as a known steel alloy. Those skilled in the art will recognize that the steel and/or iron components used in engine construction have high surface tensions, typically much greater than 1000 dyne/cm. The body 29 defines, in part, a cavity 28 in which oil can flow, and separates a top surface (not shown) that defines, in part, the combustion chamber 12 (shown in FIG. 1) from a bottom surface 27 of the piston 15. In the illustrated embodiment, the oil that flows from an oil reservoir into the cavity 28 and the piston-liner area 21.

The annular side surface 22 defines a plurality of annular grooves 23 that includes a first groove 23a, a second groove 23b and a third groove 23c. A first, second and third rings 25a, 25b and 25c are positioned within the first, second and third grooves 23a, 23b and 23c, respectively. An outer surface 20 of each ring 25a-c is in contact with the inner surface 26 of the liner 13. Thus, the outer surfaces 20 of the rings 25a-c and the inner surface 26 of the liner 13 are contact wear surfaces. Those skilled in the art will appreciate that the tension between the liner 13 and the rings 25a-c is designed such that the piston 15 can move between the top dead center position and the bottom dead center position as desired and such that the rings can provide an efficient seal for the combustion chamber 12. As the piston 15 moves from the bottom dead center position to the top dead center position, the rings 25a-c will move the oil from the piston-liner area 21 adjacent to the bottom surface 27 to the piston-liner are 21 adjacent to the top surface, creating a thin layer of oil that acts as lubrication for the rings 25a-c and liner 13 contact. Those skilled in the art will appreciate that the three rings 25a-c may have different shapes, and together seal the piston-liner area 21 from the combustion chamber 12, conduct heat from the piston 15 to the liner 13 and maintain oil lubrication in the piston-liner area 21. The third ring 25c is illustrated as defining an opening 28 through which oil can flow back to the reservoir.

The annular side surface 22 of the piston 15 also includes a plurality of lands 24a-d that separate the rings 25a-c from one another and the top and bottom surface 27 of the piston 15. The lands 24a-d do not make contact with the inner surface 26 of the liner 13. Thus, the lands 24a-d and the annular groves 23a-c are non-contact wear surfaces.

A relatively low surface tension coating 30 that includes a surface tension that is equal to or less than 30 dyne/cm is adhered to the annular side surface 22. Although the coating 30 is preferably adhered to the annular side surface 22 of the piston 15, it should be appreciated that the present disclosure contemplates the coating 30 being attached to any engine component that could be subjected to carbon deposits. Thus, the coating 30 is applicable to any non-contact wear surface of an engine component that is not subjected to temperatures at which the carbon is combusted. Although the coating 30 can include various material having a surface tension equal to or less than 30 dyne/cm, such as nickel-phosphorous, the relatively low surface tension coating 30 preferably includes nickel polytetrafluoroethylene (PTFE). The nickel forms a metallic matrix in which the polytetrafluoroethylene is dispersed. The nickel matrix provides structural integrity to the coating 30, while the polytetrafluoroethylene imparts its low surface tension. Those skilled in the art appreciate that polytetrafluoroethylene (PTFE) and that any various other compounds from the “Teflon” family, including, but not limited to, PTFE, FEP, PFA and ETFE, can be deposited within the nickel matrix and used to impart their low surface tension to the coating 30. PTFE has a surface tension of 18 dyne/cm, and all members of the “Teflon” family include surface tensions between 16-22 dyne/cm. Those skilled in the art will also appreciate that the nickel matrix will have a higher surface tension than the PTFE. Thus, the surface tension of the coating 30 will vary depending on the amount of nickel within the coating 30, but in all embodiments, will have a surface tension less than 30 dynes/cm. Because carbon has a surface tension of approximately 40-56 dyne/cm, the coating 30 will repel, rather than attract, the carbon deposits.

Preferably, the coating 30 includes electroless nickel phosphorous-PTFE. Although an electroless nickel bath is the preferred method of applying the coating 30 to the piston 15, the present disclosure contemplates other methods, such as an electrolytic plating bath. Although the amount of PTFE that can be deposited within the nickel can range from 10-33% of the electroless nickel phosphorous-PTFE by volume, preferably the electroless nickel phosphorous-PTFE includes 18-28% PTFE, by volume. Those skilled in the art will appreciate that the percentage of PTFE can vary between 18-28% throughout the coating 30 due to the electroless bath process, and that the 10% range represents the typical state of art accuracy for an electroless bath process. The 18-28% range sufficiently imparts the surface tension of the PTFE in order to repel carbon deposits while maintaining the structural integrity of the nickel matrix in the coating 30.

Although those skilled in the art will appreciate that the coating 30 of nickel-PTFE can be as thick as 25 microns, coatings of nickel-PTFE are generally between 5 to 15 microns thick. In the preferred embodiment of the present disclosure, the coating 30 on the piston 15 is between 5-7 microns thick which does not require pre- or post-assembly changes to the geometry of the piston 15. At this preferred thickness, the coating 30 does not interfere with the cooling of the piston 15.

Referring to FIG. 3, there is shown a front sectioned diagrammatic view of the oil cooler 16 of the engine 10 of FIG. 1. The plurality of tubes 31 are mounted to the oil cooler housing 17 in a conventional manner. Those skilled in the art will appreciate that there can be various number of coolant tubes 31 made of various materials. However, in the illustrated example, the coolant tubes 31 are made from cooper which has a high surface tension, approximately 1830 dyne/cm. The tubes 31 are mounted to baffles 32 that extend partially through the cross-section of the plurality of tubes 31. Although there may be various number of baffles 32, the oil cooler 16 is illustrated as including five. When the plurality of tubes 31 are mounted in the housing 17, a serpentine oil flow path 33 around the baffles 32 and over the tubes 31 begins at inlet 18 and ends at outlet 19. Each coolant tube 31 includes a relatively high surface tension surface, being an outer surface 34 that tubes 31. In the illustrated example the outer surface 34 includes cooper. The relatively low surface tension coating 30 is attached to the outer surfaces 34 of the tubes 31. Those skilled in the art will appreciate that the thickness of the coating 30 may differ between application on the piston 15 and on the coolant tubes 31, so as not to undermine heat transfer. Although the coating 30 is generally applied to be between 5 to 15 microns thick, the coating 30 applied to the tubes 30 should be sufficiently think to repel carbon deposits while not affecting the geometry or operation of the oil cooler 16.

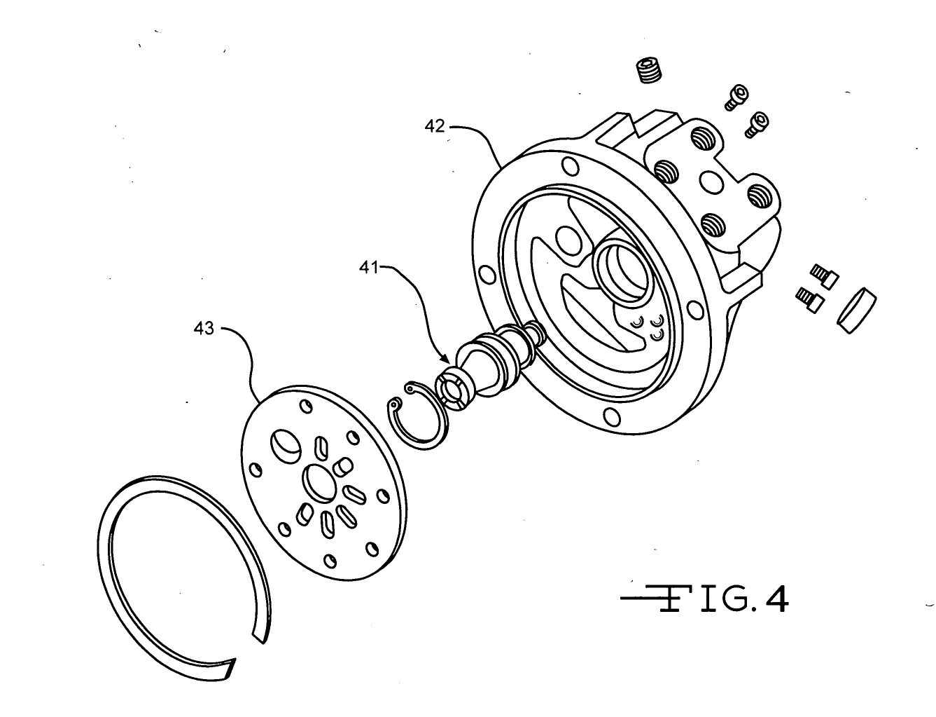

As noted above, additional carbon resistant components include a fuel injector with a coated tip. By applying a coating to the tip of the fuel injector, wherein the coating has a surface tension that is equal to or less than 30 dyne/cm, carbon deposit buildup is reduced because the carbon is prevented from anchoring on the steel. Further, carbon resistant components may be used in an active regeneration system, such as the one shown in FIG. 4. In such a system, carbon deposits can be reduced by applying a coating having a surface tension that is equal to or less than 30 dyne/cm to the tip of the mixing injector nozzle 41, to the head 42 of the active regeneration system, and/or to the swirl plate 43. Each of these components, and others in an active regeneration system or exhaust system that are prone to carbon deposits, are known in the art and are within the scope of the immediate disclosure.

### INDUSTRIAL APPLICABILITY

Referring to FIGS. 1-3, a method of reducing carbon deposits on the engine components 15, 16 of the internal combustion engine 10 will be discussed. Although the method will be discussed for the non-contact wear surfaces 22 and 34 of the engine piston 15 and the oil cooler 16, respectively, it should be appreciate that the present disclosure can operate to reduce carbon deposits similarly for any engine component subjected to carbon deposits, including, e.g., the fuel injector tips. Also, the present disclosure can operate to reduce carbon deposits via carbon reducing components integrated into the aftertreatment or exhaust systems. Engine components that include surfaces that are non-contact wear surfaces and are not subjected to temperatures sufficiently high to burn the carbon can be subjected to carbon deposits. Carbon deposits on the non-contact wear surface, being the annular surface 22, of the engine piston 15 are reduced by coating the annular surface 22 with the relatively low surface tension material, preferably nickel-PTFE. Although the PTFE imparts its relatively low surface tension, 18 dyne/cm, to the coating 30, the nickel matrix provides structural integrity to the coating 30 so the coating 30 may withstand the conditions within the engine cylinder 14 caused by the movement of the piston 15 and the fuel combustion. The nickel, being thermally conductive, does not degrade the cooling process of the piston 15.

In order to coat the annular surface of the piston 15, the coating 30 is preferably applied to a total surface of the piston 15, including the surface of the rings 25a-c. The entire piston is placed into an electroless nickel bath of the type known in the art. A rack process is preferred in order to ensure that the piston lands 24a-d and grooves 23a-c are adequately covered with the coating 30. Electroless nickel plating is based upon the catalytic reduction of nickel ions on the surface being plated, and does not require an external current source. Those skilled in the art will appreciate that the bath chemistry, such as the temperature, the pH, and the surfactants, needed to properly suspend in the electroless bath and co-deposit into the nickel matrix PTFE and phosphorous is known in the art. Preferably, a phosphorous concentration that is co-deposited with the PTFE is between 7-10%. However, if the relatively low surface tension coating 30 includes electroless-nickel phosphorous rather than electroless nickel phosphorous PTFE, the electroless-nickel phosphorous can include up to 13% phosphorous.

Although the electroless-nickel bath is the preferred method of coating the piston 15, the nickel-PTFE can also be applied to the piston 15 by an electrolytic process that is known in the art. The electrolytic process uses electric current to reduce nickel salts in the electrolytic plating bath into nickel metal that deposits on the surface to be coated. PTFE can be co-deposited on the piston 15 along with the nickel. Although the electrolytic plating bath is an alternative to the electroless nickel bath, the electroless process is preferred. The electroless nickel-phosphorous PTFE is amorphous, whereas the nickel-PTFE has a crystalline structure. The amorphous electroless nickel-phosphorous PTFE is preferred because it is more inert than the crystalline nickel-PTFE. Further, the electroless nickel-phosphorous PTFE includes phosphorous that induces the amorphous character of the electroless nickel and can enhance the ability of the coating 30 to resist carbon deposits. In addition, the electroless disposition of the coating 30 does not require an external electric current. Because the electroless nickel-phosphorous PTFE coating 30 on the piston 15 is preferably 5-7 micron thick, no pre- or post-plating changes are needed to the geometry of the piston 15 and/or block before use in the engine 10. It should be appreciated that the tubes 31 of the oil cooler 16 can also be coated by the electroless nickel or electrolytic processes as described above.

Referring specifically to FIG. 2, as the piston 15 reciprocates within the cylinder 14 between top dead center and bottom dead center, the coating 30 on the top surface of the piston 15 exposed to the combustion chamber 12 may burn due to the heat caused by the fuel combustion. Those skilled in the art will appreciate that the melting point of PTFE is 327 .degree. C. However, because the annular surface 22 of the piston 15 is not exposed to the combustion chamber 12 and there is coolant flowing through the cavity 28 of the piston 15, the heat from the combustion will not bum the coating 30 on the lands 24a-d and in the ring grooves 23a-c of the annular surface 22. Thus, when carbon produced by the combustion comes in contact with the coating 30 on the annular surface 33, the carbon will be repelled by the relatively low surface tension of the coating 30. Carbon has a higher surface tension than the electroless nickel-phosphorous PTFE coating 30. Because the carbon will not adhere to the piston lands 24a-d, carbon packing will not interfere with the oil flow along the piston-liner area 21. As the piston 15 moves from bottom dead center to top dead center, the rings 20 will move oil from the bottom of the piston-liner area 21 to the top of the piston-liner area 21, creating a thin surface of oil along the piston-liner area 21. Excess oil will not enter the combustion chamber 12. Further, because the carbon will not adhere to the ring grooves 23a-c, the tension between the piston rings 25a-c and the cylinder liner 13 will remain lesser affected by carbon deposits, allowing the piston rings 25a-c to move along the thin layer of oil as per design parameters. However, the movement of the piston rings 25a-c move against the liner 13 may cause limited movement, or lashing, of the rings 25a-c against the annular surface 22. Because the coating 30 includes the strength of the nickel matrix, the coating 30 will not be adversely affected by the limited movement, or lashing of the rings.

Referring specifically to FIG. 3, during operation of the engine 10, oil is being recirculated through the engine 10. As the oil passes through the engine 10, the oil absorbs heat from the working engine 10. In order to cool the recirculated oil, the oil is passed through the oil cooler 16. As the oil is passed over the bundle of tubes 31 coated with the relatively low surface tension coating 30, the carbon suspended in oil will be repelled, rather than adhere, to the coating 30. Thus, the oil will not leave carbon deposits that could affect the life of the tubes 31 and interfere with the thermal transfer between the coolant within the tubes 31 and the oil. The coolant within the tubes 31 will absorb the heat from the oil, thereby cooling the oil.

The present disclosure is advantageous because the coating 30 prevents adverse consequences of carbon packing, and deposits such as decreased fuel efficiency, shortened engine component life, and possible engine failure, without requiring expensive alterations to the engine 10. By coating the piston 15 and the coolant tubes 31 with the robust, relatively low surface tension coating 30, the carbon deposits are repelled from the non-contact wear surfaces 22 and 34 of the piston 15 and coolant tubes 31, respectively. The 18-28% of PTFE within the electroless nickel matrix is a compromise between low surface tension and structural integrity. The PTFE imparts its low surface tension into the coating 30 without affecting the bond strength of the nickel matrix which is required for the application of the coating 30 in the engine cylinder 14. The coating 30 can withstand the movement and load of the rings 25a-c against the annular surface 22 of the piston 15 as the piston 15 reciprocates. Moreover, the coating 30, as evidenced by its application in the oil cooler 16, can find application in a variety of environments. Further, because the total surface of the piston 15 is coated with the electroless nickel-phosphorous PTFE, the coating 30 can act as a low-friction coating for wear surfaces, such as a piston-pin contact area at the bottom of the piston 15, that it happens to cover. Overall, the engine life and performance may be improved by the carbon deposit resistant components without making major alterations to the engine 10.

With respect to the use of a carbon resistant component in a regeneration system, the carbon resistant component may be, e.g., the mixing fuel injector tip, the head, or the swirl plate. Regeneration systems are used to regenerate particle traps by heating the traps to burn the particulate matter off of the particulate trap. One method of heating comprises burning fuel in the exhaust section of the machine, which includes several or all of the steps generally associated with combusting fuel. For instance, the mixing injector nozzle, used to mix fuel and air for combustion, is prone to carbon deposits under specific circumstances. But by coating the tip of the mixing injector nozzle according to the immediate disclosure, such carbon deposits can be diminished or avoided. Other components of the regeneration system that are prone to form carbon deposits are the regeneration system head and swirl plate. By coating at least one relatively high surface tension surface of any of these components with a relatively low surface tension coating, i.e., one having a surface tension of 30 dynes/cm or less, carbon deposition is diminished or avoided altogether.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A regeneration system for an engine, the regeneration system including at least one carbon deposit resistant component, the carbon deposit resistant component comprising:
a relatively high surface tension surface being a non-contact wear surface; and
a relatively low surface tension coating adhered to the relatively high surface tension surface of the engine component, the relatively low surface tension coating having a surface tension of about 30 dynes/cm or less.

2. The regeneration system of claim 1 wherein the relatively low surface tension coating includes nickel polytetrafluoroethylene.

3. The regeneration system of claim 2 wherein the relatively low surface tension coating includes electroless nickel phosphorous-polytetrafluoroethylene.

4. The regeneration system of claim 3 wherein the electroless nickel phosphorous-polytetrafluoroethylene includes 10-33% polytetrafluoroethylene by volume.

5. The regeneration system of claim 3 wherein the electroless nickel phosphorous-polytetrafluoroethylene includes 18-28% polytetrafluoroethylene by volume.

6. The regeneration system of claim 1 wherein the regeneration system component is a mixing injector nozzle, and the surface on which the relatively low surface tension coating is applied includes the tip of the mixing injector nozzle.

7. The regeneration system of claim 1 wherein the regeneration system component is a head.

8. The regeneration system of claim 1 wherein the regeneration system component is a swirl plate.

9. The regeneration system of claim 1 wherein the relatively low surface tension coating has a thickness of about seven microns or less.

10. A method of reducing carbon deposits on at least one non-contact wear surface of a regeneration system component, comprising:
coating a surface of the regeneration system component with a relatively low surface tension material that includes a surface tension of 30 dynes/cm or less.

11. The method of claim 10 wherein the relatively low surface tension material includes nickel polytetrafluoroethylene.

12. The method of claim 11 wherein the step of coating a surface of the regeneration system component includes applying the relatively low surface tension material to the tip of a mixing nozzle in an electroless nickel bath.

13. The method of claim 11 wherein the step of coating a surface of the regeneration system component includes applying the relatively low surface tension material to a tip of a mixing nozzle in an electrolytic plating bath.

14. The method of claim 11 wherein the regeneration system component is a head.

15. The method of claim 11 wherein the regeneration system component is a swirl plate.

16. The method of claim 15 wherein the step of coating includes a step of applying the coating to the swirl plate in an electroless plating bath.

17. A carbon deposit resistant engine fuel injector comprising:
a fuel injector body and a fuel injector tip, the tip having a relatively high surface tension surface being a non-contact wear surface; and
a relatively low surface tension coating being attached to the relatively high surface tension surface, wherein the coating has a surface tension of about 30 dynes/cm or less.

18. The engine fuel injector of claim 17 wherein the relatively low surface tension coating includes nickel polytetrafluoroethylene.

19. The engine fuel injector of claim 18 wherein the relatively low surface tension coating includes electroless nickel phosphorous-polytetrafluoroethylene.

20. The engine fuel injector of claim 19 wherein the electroless nickel phosphorous-polytetrafluoroethylene includes 18-28% of polytetrafluoroethylene by volume.
